(19) United States
(12) Patent Application Publication
(10) Pub. No.: US 2004/0018914 A1
(43) Pub. Date: Jan. 29, 2004

(54) Linear position sensing employing two geartooth sensors, a helical gear and a spur gear

(76) Inventor: Joel D. Stolfus, Freeport, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/208,411

(22) Filed: Jul. 29, 2002

(51) Int. Cl. B60K 41/04; F16H 59/00

(52) U.S. Cl. 477/115; 74/336 R

(57) ABSTRACT

Methods and systems for detecting the linear movement of a shaft utilizing at least two geartooth sensors and two gears, one helical gear and one a normal spur gear are disclosed. As the shaft and gears translate in a linear direction, they are also rotating. Due to the fact one gear is a helical gear and the other is not, as the shaft translates mechanically, there will be a change in the phase between the output of a first geartooth sensor with respect to the second geartooth sensor. This change in phase is converted into linear travel using a simple calculation to detect the linear translation of the shaft.

### TECHNICAL FIELD

The present invention is generally related to sensing methods and systems. The present invention is additionally related to sensors utilized in automotive and mechanical applications. The present invention is also related to geartooth sensors.

### BACKGROUND OF THE INVENTION

Various sensors are known in the magnetic effect sensing arts. Examples of common magnetic effect sensors include Hall effect and magnetoresistive technologies. Such magnetic sensors will generally respond to a change in the magnetic field as influenced by the presence or absence of a ferromagnetic target object of a designed shape passing by the sensory field of the magnetic effect sensor. The sensor can then provide an electrical output, which can be further modified as necessary by subsequent electronics to yield sensing and control information. The subsequent electronics may be located either onboard or outboard of the sensor package.

Geartooth sensors are known in the automotive arts to provide information to an engine controller for efficient operation of the internal combustion engine. One such known arrangement involves the placing of a ferrous target wheel on the crankshaft of the engine with the sensor located proximate thereto. The target objects or features, e.g., tooth and slot, are, of course, properly keyed to mechanical operation of engine components.

Some geartooth sensors utilize one or more Hall effect elements disposed in a housing, which, in many applications, is generally cylindrical with an operative face at one end of the housing. A sensing element, such as a Hall effect element, can be disposed within the housing in association with related circuitry that is connected in electrical communication with the Hall effect element.

When a geartooth sensor is associated with a rotatable member, such as a gear, for the purpose of measuring the rotational speed of the rotatable member or, alternatively, its angular position, the Hall effect element is commonly associated with a biasing magnet that is disposed proximate the Hall effect element within the housing with the Hall effect element being disposed between the biasing magnet and the rotatable member. The biasing magnet provides a magnetic field that affects the operation of the Hall effect element when the proximity of a magnetic material, such as the rotatable member, distorts the magnetic field, which is sensed by the Hall effect element. To facilitate this type of sensing operation, the rotatable member is provided with at least one discontinuity in its surface. In many applications, a single depression is provided in the rotatable member while in other applications a plurality of gearteeth are disposed around the periphery of the rotatable member for sensing by the geartooth sensor.

In a typical application of a geartooth sensor, both the rotatable member and the sensor are disposed within a common apparatus such as an internal combustion engine. The rotatable member can be attached to a camshaft while the geartooth sensor is disposed in an opening within the body of the internal combustion engine. The geartooth sensor is typically disposed in the opening of an engine with the Hall effect element being located proximate to the surface of the rotatable member.

A problem that is typically encountered in rotatable sensing applications, such as, for example, automotive crankshaft and camshaft applications, is the inability of present sensing methods and systems to adequately detect linear movement of the shaft itself. The linear translation of a shaft is particularly important in mechanical applications in which rotating gears are utilized. Such rotating gears may be attached to a shaft. A geartooth sensor can be utilized to detect the rotational movement of gears attached to the shaft, but prior art sensor configurations do not adequately detect the linear movement of such shafts. The present inventor has thus concluded, based on the foregoing, that a need exists for a method and system that can detect the linear translation of the shaft. The present inventor further believes that such systems would be particularly useful in automotive applications. The invention disclosed herein thus offers a unique and novel solution to the aforementioned problem.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide an improved sensor method and system.

It is another aspect of the present invention to provide an improved geartooth sensor method and system.

It is yet another aspect of the present invention to provide a method and system for sensing linear position using at least two geartooth sensors.

It is also an aspect of the present invention to provide improved sensor methods and systems for automotive and other mechanical applications.

The above and other aspects of the invention can be achieved as will now be briefly described. A method and system for detecting a linear movement of a shaft is disclosed herein. A shaft is generally connected to a first gear and a second gear, such that the first and second gears are respectively associated with a first sensor and a second sensor. The shaft along with the first and second gears can be rotated in a rotatable direction while the shaft and the first and second gears simultaneously translate mechanically in a linear direction perpendicular to the rotatable direction, thereby generating a change in a phase between an output of the first sensor and an output of the second sensor. The change in phase can then be converted into a linear travel value that provides an indication of a linear translation of the shaft. The first gear can be configured as a spur gear, while the second gear can be configured as a helical gear. The first and second gears may each also be configured as geartooth sensors.

The present invention can generally be implemented as methods and/or systems for detecting the linear movement of a shaft using two geartooth sensors and two gears, at least one helical gear and at least one normal spur gear. As the shaft and gears translate in a linear direction, they are also rotating. Due to the fact one gear is a helical gear and the other is not, as the shaft translates, there will be a change in the phase between the output of a first geartooth sensor with respect to the second geartooth sensor. This change in phase can be converted into linear travel using a simple calculation as will become apparent to those skilled in the art. The two gears can also be remote from one another and, additionally, the sensors can be separate from one another as long as the associated gear drive system is mechanically coupled. An example of where the present invention is useful is on an internal combustion engine. One possible use for the present invention includes variable valve timing where the translation of the shaft is used to alter the opening and closing of engine valves in response to certain engine conditions, such as, for example, load, speed, and so forth.

The novel features of the present invention will become apparent to those of skill in the art upon examination of the following detailed description of the invention or can be learned by practice of the present invention. It should be understood, however, that the detailed description of the invention and the specific examples presented, while indicating certain embodiments of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a schematic diagram illustrating a linear position sensing method and system employing two geartooth sensors, a helical gear and a spur gear, in accordance with a preferred embodiment of the present invention;

FIG. 2 depicts a timing diagram illustrating phase differentials between sensor outputs as a function of linear translation, in accordance with a preferred embodiment of the present invention;

FIG. 3 depicts a schematic diagram illustrating an example of a sensor phase output shift per linear movement implemented in accordance with a preferred embodiment of the present invention; and

FIG. 4 depicts a graph and an associated table illustrating a linear position sensor implemented in accordance with a preferred embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

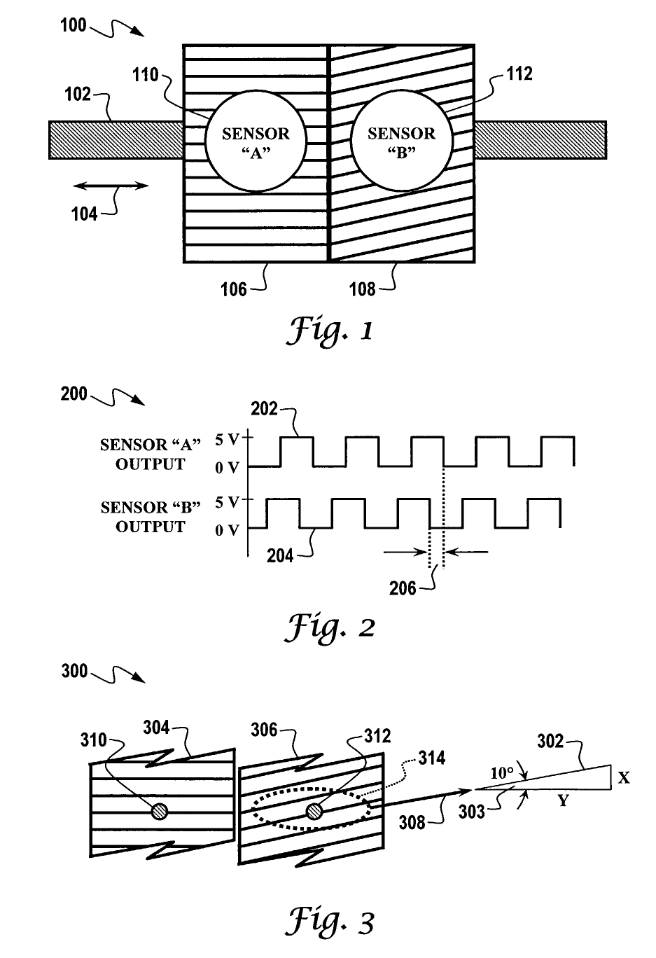

FIG. 1 depicts a schematic diagram illustrating a linear position sensing method and system 100 employing two geartooth sensors 110 and 112, at least one helical gear 108 and at least one spur gear 106, in accordance with a preferred embodiment of the present invention. Geartooth sensors 110 and 112 are respectively associated with spur gear 106 and helical gear 108. Spur gear 106 and helical gear 108 are located centrally about a rotatable shaft 102. Shaft 102 comprises a rod-like member upon which gears 106 and 108 rotate.

Arrow 104 indicates linear translation associated with shaft 102. Spur gear 106 generally comprises a first gear while helical gear 108 comprises a second gear. Shaft 102, along with the first and second gear (i.e., respectively spur gear 106 and helical gear 108) can be rotated in a rotatable direction while shaft 102 and the first and second gears simultaneously translate in a linear direction (i.e., see arrow 104), which is perpendicular to the rotatable direction, thereby generating a change in a phase between an output of the first sensor and an output of the second sensor.

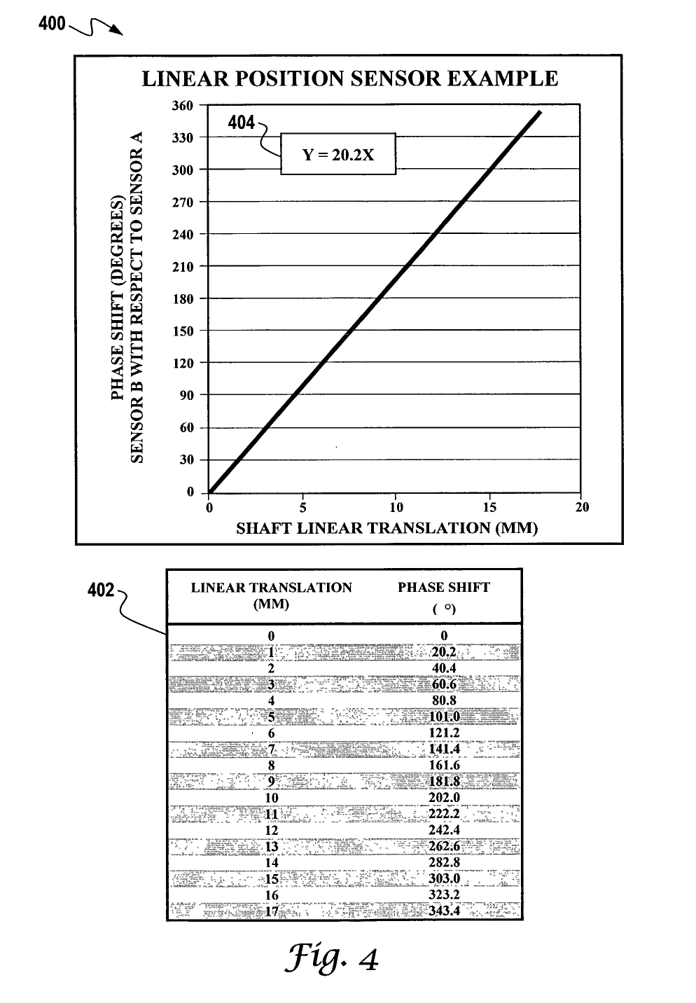

As shaft 102 and gears 106 and 108 translate in a linear direction (i.e., see arrow 104), they also rotate. Due to the fact one gear is a helical gear and the other is not, as shaft 102 translates mechanically, there will be a change in the phase between the output of the first geartooth sensor 110 with respect to the second geartooth sensor 112. This change in phase can be converted into linear travel using a simple calculation as will become apparent to those skilled in the art. An example of such a calculation is illustrated and described herein with respect to FIGS. 3 and 4. The two gears 106 and 108 can also be located remote from one another. Additionally, the sensors 110 and 112 can be separated from one another as long as the associated gear drive system is mechanically coupled.

An example of where the present invention is useful is on an internal combustion engine. One possible use for the present invention includes variable valve timing where the translation of the shaft is used to alter the opening and closing of engine valves in response to certain engine conditions such as for example, load, speed, and so forth. Thus, the configuration illustrated in FIG. 1 can be utilized to sense valve position via at least two gears (i.e., gears 106 and 108).

FIG. 2 depicts a timing diagram 200 illustrating a phase 206 generated between sensor outputs as a function of linear translation, in accordance with a preferred embodiment of the present invention. A sensor “A” output 202 is illustrated in comparison to a sensor “B” output 204. Output 202 can be generated by sensor 110 depicted in FIG. 1. Similarly, output 204 can be generated by sensor 112 indicated in FIG. 1. Thus, sensor outputs 202 and 204 of FIG. 2 are associated with geartooth sensors 110 and 112 of FIG. 1. Phase 206 occurs between sensor outputs 202 and 204 as a function of linear translation.

FIG. 3 illustrates a schematic diagram 300 of an exemplary sensor phase output shift per linear movement that implemented in accordance with a preferred embodiment of the present invention. FIG. 3 illustrates an exemplary embodiment of the present invention and does not represent a limiting feature of the present invention. It can be appreciated that other variations (e.g., other values, diameters, angles, number of teeth, etc.) may be implemented in accordance with varying embodiments of the present invention. FIG. 3 is thus presented for general illustrative and edification purposes only.

A section 304 indicated in FIG. 3 comprises a small section of the spur gear 106 depicted in FIG. 1. A location 310 shown in FIG. 3 generally comprises a sensitive location of a sensor 110 (i.e., sensor “A”), which is depicted in FIG. 1. Additionally, a section 306 indicated in FIG. 3 generally comprises a small section of gear 108 (i.e., helical gear), which is also illustrated in FIG. 1. Dashed circle 314 and an arrow 308 are illustrated in FIG. 3 to highlight the region of the helical gear (i.e., gear 108 of FIG. 1) that will translate with respect to sensor 112 (i.e., sensor “B”). Triangle 302 represents a triangle illustrating the mathematical relationship of the helix angle 303 (e.g., 10 degrees), wherein “y” represents the translation movement and “x” represents a change in the switchpoint for sensor 112 (i.e., sensor “B”).

Several assumptions can be generally made with respect to FIG. 3. For example, the gear helix angle 303 of 10 degrees is assumed. A gear diameter of 30 mm is assumed, along with a particular number of teeth associated with the geartooth sensors. In the illustration depicted in FIG. 3, assume that thirty gear teeth are utilized. Thus, the following example calculation is presented with respect to FIG. 3 for illustrative purposes:

Assumptions

Gear helix angle=10°

Gear diameter=30 mm

Number of teeth on each gear=30

Calculations

Gear circumference=94.25 mm

Tooth to tooth spacing=360°/30=12°

94.25 mm/360°=0.2618 mm /1°

Therefore, 12 gear°=3.1415 mm gear circumference arc=360° sensor output phase shift

Calculate the amount of sensor output phase shift (x) per linear movement (y).

Assume y=1 mm

Tan 10°=x/1

x=0.1763 mm

Therefore, every 1 mm of linear shaft movement results in a 0.1763 mm of arc change in switchpoint of sensor “B” (i.e., sensor 110 of FIG. 1) with respect to sensor “A” (i.e., sensor 112 of FIG. 2). Note that the term “switchpoint” as utilized herein generally refers to the point in the gear rotation where the sensor switches or changes state. A change of state can mean, for example, to go from a “low” output voltage to a “high” output voltage or from a “high” output voltage to a “low output voltage.

Thus, if 3.1415 mm=360° phase shift, then 0.1763 mm=20.20° phase shift, given the following parameters:

3.1415 mm/360°=0.1763 mm/α

α=20.20°

Therefore, 360° of phase shift would equal 17.82 mm of linear movement, with the following parameters:

1 mm/20.20°=βmm/360°

β=17.82 mm

FIG. 4 depicts a graph 400 and an associated table 402 illustrating a linear position sensor that may be implemented in accordance with a preferred embodiment of the present invention. Graph 400 represents a linear position example, particularly illustrating a shaft linear translation in millimeters versus a phase shift (i.e., in degrees) of a sensor “B” with respect to a sensor “A”. Note that sensor “A” is generally analogous to sensor 110 depicted in FIG. 1 and sensor “B” is generally analogous to sensor 112, which is also illustrated in FIG. 1. Note that the table 402 generally represents the data that generated the graph 400. The graph 400 indicates that the function is linear, which makes using the sensor easier in a system because it is a linear equation as opposed to a sensor that provides a non-linear output function that would need to be described by a polynomial equation. Even then, the accuracy of the system can suffer because of the polynomial fit. Even in such a case, however, this may not be as desirable as a linear fit. Graph 400 demonstrates how one may measure the phase shift (i.e., y axis) and can thereafter estimate the linear translation of the shaft (i.e., x axis). Note that a formula 404 is illustrated within graph 400 to illustrate how a shaft translation distance can be calculated from a measured phase shift.

Based on the foregoing, it can be appreciated that the present invention discloses methods and systems for detecting a linear movement of a shaft. A shaft is generally connected to a first gear and a second gear, such that the first and second gears are respectively associated with a first sensor and a second sensor. The shaft along with the first and second gears can be rotated in a rotatable direction while the shaft and the first and second gears simultaneously translate in a linear direction perpendicular to the rotatable direction, thereby generating a change in a phase between an output of the first sensor and an output of the second sensor. The change in phase can then be converted into a linear travel value that provides an indication of a linear translation of the shaft. The first gear can be configured as a spur gear, while the second gear can be configured as a helical gear. The first and second gears can each also be configured as geartooth sensors.

The present invention can be implemented to detect the linear movement of a shaft using two geartooth sensors and two gears, one helical gear and one normal spur gear. As the shaft and gears translate in a linear direction, they are also rotating. Due to the fact one gear is a helical gear and the other is not, as the shaft translates, there will be a change in the phase between the output of a first geartooth sensor with respect to the second geartooth sensor. This change in phase can be converted into linear travel using a simple calculation. The two gears can also be remote from one another and the sensors can be additionally separate from one another as long as the associated gear drive system is mechanically tied together. An example where the method and system disclosed herein is useful is on an internal combustion engine. One possible use for the present invention disclosed herein includes variable valve timing where the translation of the shaft is used to alter the opening and closing of engine valves in response to certain engine conditions, such as, for example, load, speed, and so forth.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows.

Having thus described the invention what is claimed is:

1. A method for detecting a linear movement of a shaft, said method comprising the steps of:
connecting a shaft to a first gear and a second gear, wherein said first and second gears are respectively associated with a first sensor and a second sensor;
rotating said shaft and said first and second gears in a rotatable direction while said shaft and said first and second gears simultaneously translate mechanically in a linear direction perpendicular to said rotatable direction, thereby generating a change in a phase between an output of said first sensor and an output of said second sensor; and
converting said change in phase into a linear travel value that provides an indication of a linear translation of said shaft.

2. The method of claim 1 further comprising the step of:
configuring said first gear as a spur gear.

3. The method of claim 1 further comprising the step of:
configuring said second gear as a helical gear.

4. The method of claim 1 further comprising the step of:
associating said first gear with a geartooth sensor.

5. The method of claim 1 further comprising the step of:
associating said second gear with a geartooth sensor.

6. The method of claim 1 further comprising the steps of:
configuring said first gear as a spur gear;
configuring said second gear as a helical gear;
associating said first gear with a geartooth sensor; and
associating said second gear with a geartooth sensor.

7. The method of claim 1 further comprising the step of:
locating said first and second gears remotely from one another.

8. The method of claim 7 further comprising the step of:
locating said first and second sensors separately from one another.

9. The method of claim 1 wherein said shaft comprises a shaft adapted for use with an internal combustion engine.

10. The method of claim 9 further comprising the step of:
detecting said translation of said shaft in order to alter an opening and closing of an engine valve associated with said internal combustion engine in response to a an engine condition thereof.

11. The method of claim 1 wherein said engine condition thereof comprises a load associated with said engine.

12. The method of claim 1 wherein said engine condition thereof comprises a speed associated with said engine.

13. The method of claim 1 wherein said shaft comprises a rotatable shaft.

14. A method for detecting a linear movement of a shaft, said method comprising the steps of:
connecting a shaft to a spur gear and a helical gear, wherein said spur gear and said helical gear are respectively associated with a first geartooth sensor and a second geartooth sensor;
rotating said shaft and said spur gear and said helical gear in a rotatable direction while said shaft and said spur gear and said helical gear simultaneously translate mechanically in a linear direction perpendicular to said rotatable direction, thereby generating a change in a phase between an output of said first geartooth sensor and an output of said second geartooth sensor; and
converting said change in phase into a linear travel value that provides an indication of a linear translation of said shaft.

15. A system for detecting a linear movement of a shaft, said system comprising:
a shaft connected to a first gear and a second gear, wherein said first and second gears are respectively associated with a first sensor and a second sensor;
a rotating mechanism for rotating said shaft and said first and second gears in a rotatable direction while said shaft and said first and second gears simultaneously translate in a linear direction perpendicular to said rotatable direction, thereby generating a change in a phase between an output of said first sensor and an output of said second sensor; and
a converting mechanism for converting said change in phase into a linear travel value that provides an indication of a linear translation of said shaft.

16. The system of claim 15 wherein said first gear comprises a spur gear.

17. The system of claim 15 wherein said second gear comprises a helical gear.

18. The system of claim 15 wherein said first gear is associated with a geartooth sensor.

19. The system of claim 15 wherein said second gear is associated with a geartooth sensor.

20. The system of claim 15 wherein:
said first gear comprises a spur gear;
said second gear comprises a helical gear;
said first gear is associated with a geartooth sensor; and
said second gear is associated with a geartooth sensor.

21. The system of claim 15 wherein said first and second gears are located remotely from one another.

22. The system of claim 21 wherein said first and second sensors are located separately from one another.

23. The system of claim 15 wherein said shaft comprises a shaft adapted for use with an internal combustion engine.

24. The system of claim 23 further comprising:
a detecting mechanism for detecting said translation of said shaft in order to alter an opening and closing of an engine valve associated with said internal combustion engine in response to a an engine condition thereof.

25. The system of claim 15 wherein said engine condition thereof comprises a load associated with said engine.

26. The system of claim 15 wherein said engine condition thereof comprises a speed associated with said engine.

27. The system of claim 15 wherein said shaft comprises a rotatable shaft.

28. A system for detecting a linear movement of a shaft, said system comprising:
a shaft connected to a spur gear and a helical gear, wherein said spur gear and said helical gear are respectively associated with a first geartooth sensor and a second geartooth sensor;
a rotating mechanism for rotating said shaft and said spur gear and said helical gear in a rotatable direction while said shaft and said spur gear and said helical gear simultaneously translate in a linear direction perpendicular to said rotatable direction, thereby generating a change in a phase between an output of said first geartooth sensor and an output of said second geartooth sensor; and
a converting mechanism for converting said change in phase into a linear travel value that provides an indication of a linear translation of said shaft.
